(19) United States
(12) Patent Application Publication
(10) Pub. No.: US 2023/0134620 A1
(43) Pub. Date: May 4, 2023

(54) METHOD AND SYSTEM FOR REAL-TIME ANALYTIC OF TIME SERIES DATA

(71) Applicant: JPMorgan Chase Bank, N.A., New York, NY (US)

(72) Inventors: Alan FITZGERALD, Kinsale (IE); Uri KLEIN, New York, NY (US); Jake SAVOCA, Brooklyn, NY (US); Richard BONDI, New York, NY (US); Henry CONWAY, Aughrim (IE); Una RYAN, Limerick (IE); Ayman HAMMAD, Pleasanton, CA (US); Nikita DUTTA, Dublin (IE); Keefe TAN, Singapore (SG); Adonis POLYCHRONOPOULOS, Singapore (SG)

(73) Assignee: JPMorgan Chase Bank, N.A., New York, NY (US)

(21) Appl. No.: 17/452,688

(22) Filed: Oct. 28, 2021

(51) Int. Cl. G06Q 10/06

(52) U.S. Cl. CPC G06Q 10/0635

(57) ABSTRACT

A method for providing real-time analytics of time series data is disclosed. The method includes capturing a first set of time series data from a data flow based on a first predetermined time period; parsing the first set of time series data to identify a first key metric; capturing a second set of time series data from the data flow based on a second predetermined time period; parsing the second set of time series data to identify a second key metric, the second key metric corresponding to the first key metric; comparing, in real-time, the second key metric with the first key metric; and identifying, by using a model, an anomaly based on a result of the comparing and a predetermined threshold.

### BACKGROUND

### 1. Field of the Disclosure

This technology generally relates to methods and systems for data analytics, and more particularly to methods and systems for providing real-time and/or near real-time analytics of time series data to identify anomalous data patterns and alert stakeholders.

### 2. Background Information

Many business entities such as, for example, payment processing merchants manage large flows of time series data. The time series data may relate to important customer transaction information that impact business outcomes. Historically, implementation of conventional analytic techniques for the time series data has resulted in varying degrees of success with respect to effective and efficient identification of anomalous data patterns in the time series data.

One drawback of using the conventional analytic techniques is that in many instances, anomalous data patterns are not efficiently and effectively identified in the time series data. The anomalous data patterns may indicate malicious activities, third-party activities, and business transformations that adversely impact business outcomes. As a result, the anomalous data patterns are not mitigated in a timely manner and adversely impacts the business entity.

Therefore, there is a need to provide real-time and/or near real-time analytics of time series data to identify anomalous data patterns and alert relevant stakeholders.

### SUMMARY

The present disclosure, through one or more of its various aspects, embodiments, and/or specific features or sub-components, provides, inter alia, various systems, servers, devices, methods, media, programs, and platforms for providing real-time and/or near real-time analytics of time series data to identify anomalous data patterns and alert stakeholders.

According to an aspect of the present disclosure, a method for providing real-time and/or near real-time analytics of time series data is disclosed. The method is implemented by at least one processor. The method may include capturing a first set of time series data from a data flow based on a first predetermined time period; parsing the first set of time series data to identify at least one first key metric; capturing a second set of time series data from the data flow based on a second predetermined time period; parsing the second set of time series data to identify at least one second key metric, the at least one second key metric may correspond to the at least one first key metric; comparing, in real-time, the at least one second key metric with the at least one first key metric; and identifying, by using at least one model, at least one anomaly based on a result of the comparing and a predetermined threshold.

In accordance with an exemplary embodiment, the first set of time series data and the second set of time series data may include at least one from among a transaction rate and a transaction volume, and the first predetermined time period may correspond to a window of time that precedes the second predetermined time period.

In accordance with an exemplary embodiment, the method may further include capturing a third set of time series data from the data flow based on a third predetermined time period, the third predetermined time period may correspond to the first predetermined time period; parsing the third set of time series data to identify at least one third key metric, the at least one third key metric may correspond to the at least one first key metric; and determining at least one average key metric based on the at least one third key metric and the at least one first key metric, the at least one average key metric may relate to an arithmetic mean of the at least one third key metric and the at least one first key metric.

In accordance with an exemplary embodiment, the method may further include comparing, in real-time, the at least one second key metric with the at least one average key metric; and identifying, by using the at least one model, at least one normalized anomaly based on a result of the comparing and the predetermined threshold.

In accordance with an exemplary embodiment, the method may further include verifying each of the at least one anomaly based on at least one internal resource; and automatically determining an action for each of the at least one anomaly based on a result of the verifying, the action may include at least one from among a manual review action and an automated alerting action.

In accordance with an exemplary embodiment, for the automated alerting action, the method may further include identifying at least one stakeholder that corresponds to the at least one anomaly, the at least one stakeholder may include at least one from among an internal stakeholder and an external stakeholder; retrieving at least one predetermined preference that corresponds to the at least one stakeholder, the at least one predetermined preference may relate to an alerting subscription; and generating an alert for the at least one stakeholder based on the at least one predetermined preference.

In accordance with an exemplary embodiment, to generate the alert, the method may further include automatically determining at least one recommended procedure to mitigate the at least one anomaly; compiling information that relates to at least one from among the at least one anomaly, the at least one first key metric, and the at least one second key metric; and generating the alert, the alert may include the at least one recommended procedure and the compiled information.

In accordance with an exemplary embodiment, the method may further include receiving feedback data from at least one stakeholder; compiling information that relates to at least one from among the at least one first key metric, the at least one second key metric, and the at least one anomaly; and updating the at least one model based on the feedback data and the compiled information.

In accordance with an exemplary embodiment, the at least one model may include at least one from among a machine learning model, a statistical model, a mathematical model, a process model, and a data model.

According to an aspect of the present disclosure, a computing device configured to implement an execution of a method for providing real-time and/or near real-time analytics of time series data is disclosed. The computing device comprising a processor; a memory; and a communication interface coupled to each of the processor and the memory, wherein the processor may be configured to capture a first set of time series data from a data flow based on a first predetermined time period; parse the first set of time series data to identify at least one first key metric; capture a second set of time series data from the data flow based on a second predetermined time period; parse the second set of time series data to identify at least one second key metric, the at least one second key metric may correspond to the at least one first key metric; compare, in real-time, the at least one second key metric with the at least one first key metric; and identify, by using at least one model, at least one anomaly based on a result of the comparing and a predetermined threshold.

In accordance with an exemplary embodiment, the first set of time series data and the second set of time series data may include at least one from among a transaction rate and a transaction volume, and the first predetermined time period may correspond to a window of time that precedes the second predetermined time period.

In accordance with an exemplary embodiment, the processor may be further configured to capture a third set of time series data from the data flow based on a third predetermined time period, the third predetermined time period may correspond to the first predetermined time period; parse the third set of time series data to identify at least one third key metric, the at least one third key metric may correspond to the at least one first key metric; and determine at least one average key metric based on the at least one third key metric and the at least one first key metric, the at least one average key metric may relate to an arithmetic mean of the at least one third key metric and the at least one first key metric.

In accordance with an exemplary embodiment, the processor may be further configured to compare, in real-time, the at least one second key metric with the at least one average key metric; and identify, by using the at least one model, at least one normalized anomaly based on a result of the comparing and the predetermined threshold.

In accordance with an exemplary embodiment, the processor may be further configured to verify each of the at least one anomaly based on at least one internal resource; and automatically determine an action for each of the at least one anomaly based on a result of the verifying, the action may include at least one from among a manual review action and an automated alerting action.

In accordance with an exemplary embodiment, for the automated alerting action, the processor may be further configured to identify at least one stakeholder that corresponds to the at least one anomaly, the at least one stakeholder may include at least one from among an internal stakeholder and an external stakeholder; retrieve at least one predetermined preference that corresponds to the at least one stakeholder, the at least one predetermined preference may relate to an alerting subscription; and generate an alert for the at least one stakeholder based on the at least one predetermined preference.

In accordance with an exemplary embodiment, to generate the alert, the processor may be further configured to automatically determine at least one recommended procedure to mitigate the at least one anomaly; compile information that relates to at least one from among the at least one anomaly, the at least one first key metric, and the at least one second key metric; and generate the alert, the alert may include the at least one recommended procedure and the compiled information.

In accordance with an exemplary embodiment, the processor may be further configured to receive feedback data from at least one stakeholder; compile information that relates to at least one from among the at least one first key metric, the at least one second key metric, and the at least one anomaly; and update the at least one model based on the feedback data and the compiled information.

In accordance with an exemplary embodiment, the at least one model may include at least one from among a machine learning model, a statistical model, a mathematical model, a process model, and a data model.

According to an aspect of the present disclosure, a non-transitory computer readable storage medium storing instructions for providing real-time and/or near real-time analytics of time series data is disclosed. The storage medium includes executable code which, when executed by a processor, may cause the processor to capture a first set of time series data from a data flow based on a first predetermined time period; parse the first set of time series data to identify at least one first key metric; capture a second set of time series data from the data flow based on a second predetermined time period; parse the second set of time series data to identify at least one second key metric, the at least one second key metric may correspond to the at least one first key metric; compare, in real-time, the at least one second key metric with the at least one first key metric; and identify, by using at least one model, at least one anomaly based on a result of the comparing and a predetermined threshold.

In accordance with an exemplary embodiment, when executed by the at least one processor, the executable code may further cause the processor to receive feedback data from at least one stakeholder; compile information that relates to at least one from among the at least one first key metric, the at least one second key metric, and the at least one anomaly; and update, by the at least one processor, the at least one model based on the feedback data and the compiled information.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing real-time and/or near real-time analytics of time series data to identify anomalous data patterns and alert stakeholders.

FIG. 4 is a flowchart of an exemplary process for implementing a method for providing real-time and/or near real-time analytics of time series data to identify anomalous data patterns and alert stakeholders.

FIG. 5 is a flow diagram of an exemplary process for implementing a method for providing real-time and/or near real-time analytics of time series data to identify anomalous data patterns and alert stakeholders.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

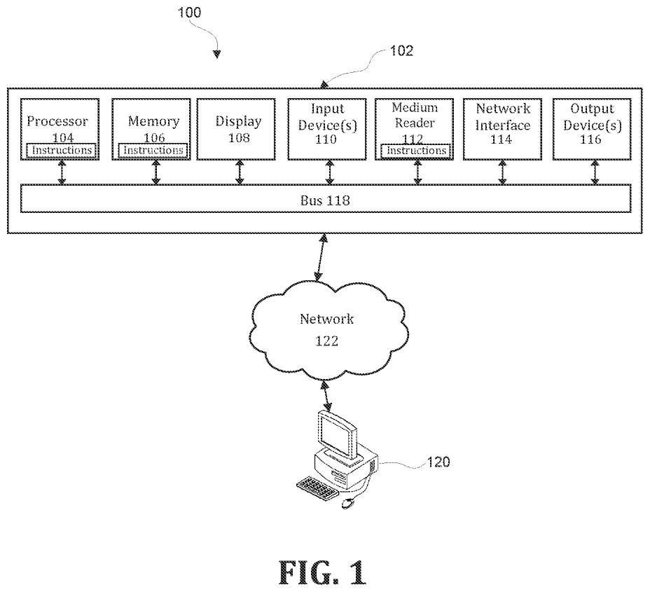

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing real-time analytics of time series data to identify anomalous data patterns and alert stakeholders.

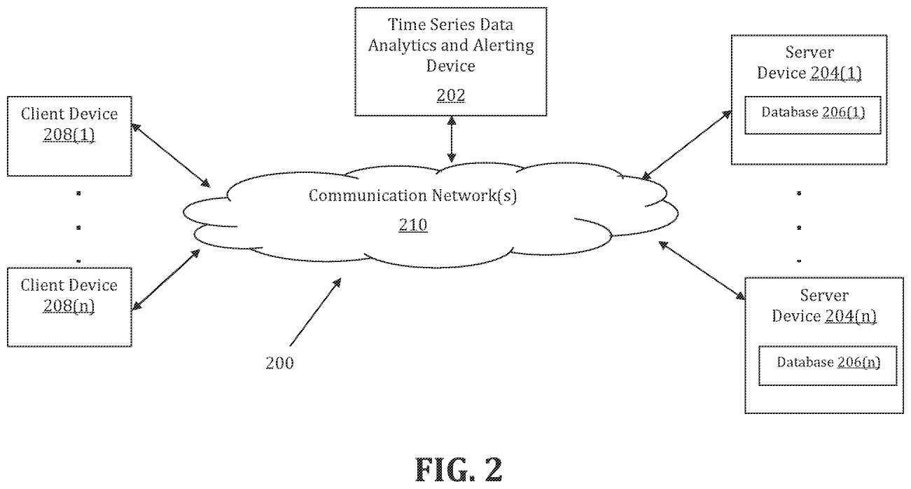

Referring to FIG. 2, a schematic of an exemplary network environment 200 for implementing a method for providing real-time analytics of time series data to identify anomalous data patterns and alert stakeholders is illustrated. In an exemplary embodiment, the method is executable on any networked computer platform, such as, for example, a personal computer (PC).

The method for providing real-time analytics of time series data to identify anomalous data patterns and alert stakeholders may be implemented by a Time Series Data Analytics and Alerting (TSDAA) device 202. The TSDAA device 202 may be the same or similar to the computer system 102 as described with respect to FIG. 1. The TSDAA device 202 may store one or more applications that can include executable instructions that, when executed by the TSDAA device 202, cause the TSDAA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the TSDAA device 202 itself, may be located in virtual server(s) running in a cloud-based computing environment rather than being tied to one or more specific physical network computing devices. Also, the application(s) may be running in one or more virtual machines (VMs) executing on the TSDAA device 202. Additionally, in one or more embodiments of this technology, virtual machine(s) running on the TSDAA device 202 may be managed or supervised by a hypervisor.

In the network environment 200 of FIG. 2, the TSDAA device 202 is coupled to a plurality of server devices 204(1)-204(n) that hosts a plurality of databases 206(1)-206(n), and also to a plurality of client devices 208(1)-208(n) via communication network(s) 210. A communication interface of the TSDAA device 202, such as the network interface 114 of the computer system 102 of FIG. 1, operatively couples and communicates between the TSDAA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the TSDAA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and TSDAA devices that efficiently implement a method for providing real-time analytics of time series data to identify anomalous data patterns and alert stakeholders.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The TSDAA device 202 may be a standalone device or integrated with one or more other devices or apparatuses, such as one or more of the server devices 204(1)-204(n), for example. In one particular example, the TSDAA device 202 may include or be hosted by one of the server devices 204(1)-204(n), and other arrangements are also possible. Moreover, one or more of the devices of the TSDAA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the TSDAA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to sets of time series data, key metrics, machine learning models, anomalies, predetermined thresholds, transaction rates, transaction volumes, internal resources, external resources, and recommended mitigation procedures.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the TSDAA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the TSDAA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the TSDAA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the TSDAA device 202, the server devices 204(1)-204(n), or the client devices 208(1)-208(n), for example, may be configured to operate as virtual instances on the same physical machine. In other words, one or more of the TSDAA device 202, the server devices 204(1)-204(n), or the client devices 208(1)-208(n) may operate on the same physical device rather than as separate devices communicating through communication network(s) 210. Additionally, there may be more or fewer TSDAA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

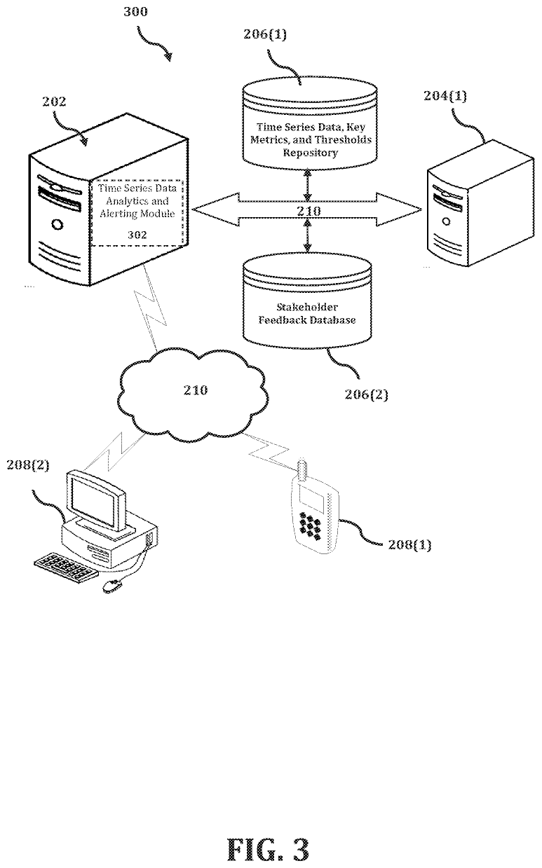

The TSDAA device 202 is described and shown in FIG. 3 as including a time series data analytics and alerting module 302, although it may include other rules, policies, modules, databases, or applications, for example. As will be described below, the time series data analytics and alerting module 302 is configured to implement a method for providing real-time analytics of time series data to identify anomalous data patterns and alert stakeholders.

An exemplary process 300 for implementing a mechanism for providing real-time analytics of time series data to identify anomalous data patterns and alert stakeholders by utilizing the network environment of FIG. 2 is shown as being executed in FIG. 3. Specifically, a first client device 208(1) and a second client device 208(2) are illustrated as being in communication with TSDAA device 202. In this regard, the first client device 208(1) and the second client device 208(2) may be “clients” of the TSDAA device 202 and are described herein as such. Nevertheless, it is to be known and understood that the first client device 208(1) and/or the second client device 208(2) need not necessarily be “clients” of the TSDAA device 202, or any entity described in association therewith herein. Any additional or alternative relationship may exist between either or both of the first client device 208(1) and the second client device 208(2) and the TSDAA device 202, or no relationship may exist.

Further, TSDAA device 202 is illustrated as being able to access a time series data, key metrics, and thresholds repository 206(1) and a stakeholder feedback database 206(2). The time series data analytics and alerting module 302 may be configured to access these databases for implementing a method for providing real-time analytics of time series data to identify anomalous data patterns and alert stakeholders.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the TSDAA device 202 via broadband or cellular communication. Of course, these embodiments are merely exemplary and are not limiting or exhaustive.

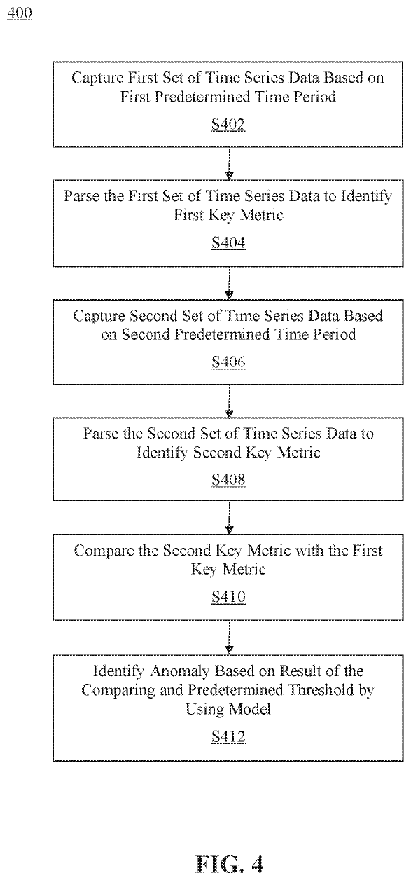

Upon being started, the time series data analytics and alerting module 302 executes a process for providing real-time analytics of time series data to identify anomalous data patterns and alert stakeholders. An exemplary process for providing real-time analytics of time series data to identify anomalous data patterns and alert stakeholders is generally indicated at flowchart 400 in FIG. 4.

In the process 400 of FIG. 4, at step S402, a first set of time series data may be captured from a data flow based on a first predetermined time period. In an exemplary embodiment, the first set of time series data may relate to data that is received in a sequence at successive points in time. The data may be received at equally spaced, successive points in time as well as at successive irregular intervals. In another exemplary embodiment, the first set of time series data may include transaction information from a payment processing merchant. The transaction information may include at least one from among an authorization rate, a transaction rate, and a transaction volume that corresponds to attempted transactions.

In another exemplary embodiment, the first set of time series data may be captured in real-time from a data flow. The data flow may correspond to a stream of transaction data from the payment processing merchant. In another exemplary embodiment, the first set of time series data may be captured from the data flow based on a predetermined schedule. For example, the predetermined schedule may dictate that the first set of time series data is captured once a day.

In another exemplary embodiment, the first set of time series data may relate to historical data that is captured to establish a baseline. For example, the first set of time series data may be captured and compared to subsequently captured data to determine whether a change in the data flow has occurred. In another exemplary embodiment, the first set of time series data may be combined with other sets of time series data to determine an average set of time series data that represents a state of the data flow. The average set of time series data may relate to an arithmetic mean of a plurality of sets of time series data.

In another exemplary embodiment, the first predetermined time period may relate to a window of time. For example, the first predetermined time period may correspond to a period of one minute, one hour, one day, and/or any combination thereof. In another exemplary embodiment, the first predetermined time period may be determined based on a user preference. The user preference may be adjusted based on input received from the user via a graphical user interface. In another exemplary embodiment, the first predetermined time period may be determined automatically based on business guidelines by using automated machine learning techniques consistent with disclosures in the present application.

At step S404, the first set of time series data may be parsed to identify a first key metric. In an exemplary embodiment, the first key metric may include information that relates to a parameter of the data flow. For transactional data flows, the parameter of the data flow may correspond to at least one from among an authorization rate, a transaction rate, and a transaction volume that corresponds to attempted transactions. As will be appreciated by a person of ordinary skill in the art, parsing of the first set of time series data may require translation of the time series data as well as mapping of the time series data to convert the time series data from one data format to another data format.

In another exemplary embodiment, the first key metric may be manually determined by a user. The user may utilize a graphical user interface to indicate specific parameters that are associated with the first key metric. For example, the user may indicate that the authorization rate is associated with the first key metric. In another exemplary embodiment, the first key metric may be automatically determined based on a business guideline by using machine learning techniques consistent with disclosures in the present application. For example, based on automatically determined patterns, a parameter such as an authorization rate may be automatically identified as one of the first key metrics.

At step S406, a second set of time series data may be captured from the data flow based on a second predetermined time period. In an exemplary embodiment, the second set of time series data may relate to data that is received in a sequence at successive points in time. The data may be received at equally spaced, successive points in time as well as at successive irregular intervals. In another exemplary embodiment, the second set of time series data may include transaction information from a payment processing merchant. The transaction information may include at least one from among an authorization rate, a transaction rate, and a transaction volume that corresponds to attempted transactions.

In another exemplary embodiment, the second set of time series data may be captured in real-time from a data flow. The data flow may correspond to a stream of transaction data from the payment processing merchant. In another exemplary embodiment, the second set of time series data may be captured from the data flow based on a predetermined schedule. For example, the predetermined schedule may dictate that the second set of time series data is captured once an hour during peak transaction processing times.

In another exemplary embodiment, the second set of time series data may relate to current data that is presently captured. The second set of time series data may relate to presently captured data that represents a current state of the data flow. For example, the second set of time series data may be presently captured and compared to previously captured data to determine whether a change in the data flow has occurred.

In another exemplary embodiment, the second predetermined time period may relate to a window of time. For example, the second predetermined time period may correspond to a period of one minute, one hour, one day, and/or any combination thereof. In another exemplary embodiment, the second predetermined time period may be determined based on a user preference. The user preference may be adjusted based on input received from the user via a graphical user interface. In another exemplary embodiment, the second predetermined time period may be determined automatically based on business guidelines by using automated machine learning techniques consistent with disclosures in the present application. Consistent with disclosures in the present application, the first predetermined time period may correspond to a window of time that precedes the second predetermined time period

At step S408, the second set of time series data may be parsed to identify a second key metric. The second key metric may correspond to the first key metric. In an exemplary embodiment, the second key metric may include information that relates to a parameter of the data flow. For transactional data flows, the parameter of the data flow may correspond to at least one from among an authorization rate, a transaction rate, and a transaction volume that corresponds to attempted transactions. As will be appreciated by a person of ordinary skill in the art, parsing of the second set of time series data may require translation of the time series data as well as mapping of the time series data to convert the time series data from one data format to another data format.

In another exemplary embodiment, the second key metric may be manually determined by a user. The user may utilize a graphical user interface to indicate specific parameters that are associated with the second key metric. For example, the user may indicate that the authorization rate is associated with the second key metric. In another exemplary embodiment, the second key metric may be automatically determined based on a business guideline by using machine learning techniques consistent with disclosures in the present application. For example, based on automatically determined patterns, a parameter such as an authorization rate may be automatically identified as one of the second key metrics.

At step S410, the second key metric may be compared with the first key metric in real-time and/or near real-time. In an exemplary embodiment, the second key metric may be compared with the first key metric in actual time and/or near actual time during which the second key metric was captured from the data flow. The comparison may be processed within a substantially short amount of time such as, for example, within a millisecond, so that a result of the comparison may be available virtually immediately after the second key metric has been captured from the data flow. In another exemplary embodiment, the second key metric and the first key matric may be compared to determine a deviation between the data sets. The deviation may relate to a measured difference between the second key metric and the first key metric.

At step S412, an anomaly may be identified based on a result of the comparing and a predetermined threshold by using a model. In an exemplary embodiment, the anomaly may relate to resulting anomalous data from the comparison between the second set of time series data and the first set of time series data. The anomalous data may correspond to data that deviates from baseline behaviors of the data flow. In another exemplary embodiment, the baseline behaviors may account for seasonal deviations in the data flow. The seasonal deviations in the data flow may be used to assess whether an event, which may be unexpected in the short term, occurs on an expected periodic basis in the long term. For example, an identified anomaly may not be alerted when the anomaly is based on a known deviation in the data flow that occurs at periodic intervals such as every week, every month, etc.

In another exemplary embodiment, the anomaly may relate to at least one from among a result of malicious activity, a third-party activity, and a business transformation. The result of malicious activity may include fraudulent transaction attempts. The third-party activity may correspond to a change in issuer policy that impacts authorization rates. The business transformation may relate to a change in consumer behavior and/or a change in offered goods/services that impact the payment transactions. In another exemplary embodiment, the anomaly may have adverse impacts on a business outcome as well as adverse impacts on perceptions of the business outcome. For example, the anomaly may adversely cause a reduction in revenue and/or an increase in cost. As will be appreciated by a person of ordinary skill in the art, early detection of the anomaly may allow for appropriate responses to mitigate the adverse effects of the anomaly.

In another exemplary embodiment, the predetermined threshold may correspond to a magnitude of deviation in the time series data that indicates an anomaly. The deviation in the time series data may correspond to a measured difference between the first set of time series data and the second set of time series data. In another exemplary embodiment, the predetermined threshold may be manually defined by a user by interacting with a graphical user interface. The user may interact with the graphical user interface to indicate a magnitude of deviation that is required before an anomaly is detected. In another exemplary embodiment, the predetermined threshold may correspond to an automatically determined threshold that is dynamically adjusted based on business guidelines. For example, the predetermined threshold may be dynamically adjusted to increase or decrease anomaly detection sensitivity during times of increased data flow. The predetermined threshold may be automatically determined and dynamically adjusted by using machine learning techniques consistent with disclosures in the present application.

In another exemplary embodiment, the model may include at least one from among a machine learning model, a statistical model, a mathematical model, a process model, and a data model. The model may also include stochastic models such as, for example, a Markov model that is used to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, logistic regression analysis, 5-fold cross-validation analysis, balanced class weight analysis, etc. In another exemplary embodiment, machine learning analytical techniques may include unsupervised learning algorithms such as, for example, Apriori analysis, K-means clustering analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

In another exemplary embodiment, an average baseline of the data flow may be determined by capturing a third set of time series data from the data flow based on a third predetermined time period. The third set of time series data may be captured together with subsequent sets of time series data based on a predetermined time period. The third predetermined time period may correspond to the first predetermined time period. Then, consistent with disclosures in the present application, the third set of time series data may be parsed to identify a third key matric. The third key metric may correspond to the first key metric. In another exemplary embodiment, an average key metric may be determined based on the third key metric and the first key metric. The average key metric may relate to an arithmetic mean of the third key metric and the first key metric.

In another exemplary embodiment, the second key metric may be compared with the average key metric in real time to determine a deviation from the average baseline of the data flow. Then, consistent with disclosures in the present application, a normalized anomaly may be identified based on a result of the comparing and the predetermined threshold by using the model.

In another exemplary embodiment, the deviation in the time series data may be confirmed by verifying each of the detected anomalies based on an internal resource. The internal resource may include at least one from among manual reviews of the anomaly as well as third-party data indicating the deviation. Then, an action may be automatically determined for each of the detected anomalies based on a result of the verifying. The action may include at least one from among a manual review action and an automated alerting action. The manual review action may indicate that further manual review of the anomaly may be required.

In another exemplary embodiment, the automated alerting action may include identifying a stakeholder that corresponds to the anomaly. The stakeholder may include at least one from among an internal stakeholder and an external stakeholder such as, for example, the payment processing merchant. Once the stakeholder has been identified, a predetermined preference that corresponds to the stakeholder may be retrieved. The predetermined preference may relate to an alerting subscription. Then, an alert for the stakeholder may be generated based on the predetermined preference. The alert may be generated for a variety of communication channels based on the predetermined preference. The communication channels may include at least one from among an email communication channel, a text message communication channel, a chat communication channel, a telephonic communication channel, as well as a direct communication channel that is integrated with a graphical user interface.

In another exemplary embodiment, generating the alert may further include automatically determining, a recommended procedure to mitigate the anomaly. The recommended mitigation procedure may relate to a recommended course of action to alleviate the effects of the anomaly. Information that relates to at least one from among the anomaly, the first key metric, and the second key metric may also be compiled. Then, the alert may be generated for the stakeholder. The alert may include the recommended mitigation procedure as well as the compiled information.

In another exemplary embodiment, a manual and/or automated feedback loop to modify and/or adjust the monitoring criteria may be implemented by receiving feedback data from the stakeholder. Resulting output data may also be compiled after the anomaly has been identified. The resulting output data may include information that relates to at least one from among the first key metric, the second key metric, the anomaly, and a result of the comparing process. The model may then be updated based on the feedback data and the compiled information.

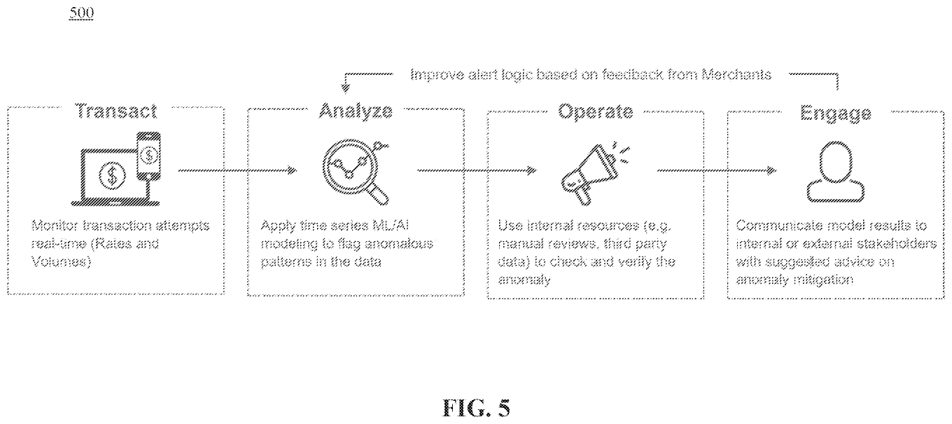

FIG. 5 is a flow diagram 500 of an exemplary process for implementing a method for providing real-time and/or near real-time analytics of time series data to identify anomalous data patterns and alert stakeholders. In FIG. 5, components such as a transact component, an analyze component, an operate component, an engage component, and a feedback component may be implemented to provide real-time and/or near real-time analytics of time series data to identify anomalous data patterns and alert stakeholders.

As illustrated in FIG. 5, the transact component may monitor transaction attempts in real-time. The transaction component may monitor transaction rates and transaction volumes. The analyze component may apply time series machine learning and/or artificial intelligence modeling techniques to flag anomalous patterns in the data. The operate component may utilize internal resources to check and verify the anomaly. The internal resources may include at least one from among manual reviews and third-party data. Then, the engage component may communicate model results to internal or external stakeholders with suggested advice on anomaly mitigation.

Exemplary use cases may be implemented by using the flow diagram in FIG. 5. In a first exemplary use case, a problem statement may indicate that card testing is a type of digital fraud that occurs when cyber criminals obtain partial credit and/or debit cards from the black market and uses a script to test a large volume of “Card Not Present” type transactions against an electronic commerce merchant to identify valid credentials. By implementing the claimed invention, the card testing may be identified in real-time by analyzing changes in aggregated data such as, for example, benchmarking key metrics across a sliding window of time. The key metrics may include at least one from among an authorization rate, a transaction volume, a transaction value amount, and a decline reason. Early detection may enable merchants to implement solutions that stop an ongoing attack or prevent future attacks, saving thousands of dollars in fees from excessive authorizations and/or lost revenue.

In a second exemplary use case, a problem statement may indicate that anomalies in a merchant's authorizations evade human detection due to the large number of permutations in features that could be subject to irregularities. The features may include at least one from among client demographics, card attributes, and authorization patterns. By implementing the claimed invention, machine learning time series modeling may be used to quickly identify anomalies and root causes in a merchant's authorization rate and volume at a variety of granularities. The various granularities may include a transaction division, a bank identification number (BIN), a card product, and a transaction type. Early detection may reduce revenue loss resulting from an artificially low authorization rate and improve merchant experience by alerting the merchant of issues in minutes instead of weeks.

Accordingly, with this technology, an optimized process for providing real-time analytics of time series data to identify anomalous data patterns and alert stakeholders is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A method for providing real-time analytics of time series data, the method being implemented by at least one processor, the method comprising:
generating, by the at least one processor, at least one model by using an artificial neural network;
training, by the at least one processor using training data, the at least one model;
assessing, by the at least one processor, the at least one model to determine whether at least one rate is within a predetermined range;
deploying, by the at least one processor, the at least one model based on a result of the assessment;
capturing, by the at least one processor, a first set of time series data from a data flow based on a first predetermined time period;
parsing, by the at least one processor, the first set of time series data to identify at least one first key metric;
capturing, by the at least one processor, a second set of time series data from the data flow based on a second predetermined time period;
parsing, by the at least one processor, the second set of time series data to identify at least one second key metric, the at least one second key metric corresponding to the at least one first key metric;
comparing, by the at least one processor in real-time, the at least one second key metric with the at least one first key metric; and
identifying, by the at least one processor using the at least one model, at least one anomaly based on a result of the comparing and a predetermined threshold.

2. The method of claim 1, wherein the first set of time series data and the second set of time series data includes at least one from among a transaction rate and a transaction volume, and wherein the first predetermined time period corresponds to a window of time that precedes the second predetermined time period.

3. The method of claim 1, further comprising:
capturing, by the at least one processor, a third set of time series data from the data flow based on a third predetermined time period, the third predetermined time period corresponding to the first predetermined time period;
parsing, by the at least one processor, the third set of time series data to identify at least one third key metric, the at least one third key metric corresponding to the at least one first key metric; and
determining, by the at least one processor, at least one average key metric based on the at least one third key metric and the at least one first key metric, the at least one average key metric relating to an arithmetic mean of the at least one third key metric and the at least one first key metric.

4. The method of claim 3, further comprising:
comparing, by the at least one processor in real-time, the at least one second key metric with the at least one average key metric; and
identifying, by the at least one processor using the at least one model, at least one normalized anomaly based on a result of the comparing and the predetermined threshold.

5. The method of claim 1, further comprising:
verifying, by the at least one processor, each of the at least one anomaly based on at least one internal resource; and
automatically determining, by the at least one processor, an action for each of the at least one anomaly based on a result of the verifying, the action including at least one from among a manual review action and an automated alerting action.

6. The method of claim 5, wherein the automated alerting action further comprises:
identifying, by the at least one processor, at least one stakeholder that corresponds to the at least one anomaly, the at least one stakeholder including at least one from among an internal stakeholder and an external stakeholder;
retrieving, by the at least one processor, at least one predetermined preference that corresponds to the at least one stakeholder, the at least one predetermined preference relating to an alerting subscription; and
generating, by the at least one processor, an alert for the at least one stakeholder based on the at least one predetermined preference.

7. The method of claim 6, wherein generating the alert further comprises:
automatically determining, by the at least one processor, at least one recommended procedure to mitigate the at least one anomaly;
compiling, by the at least one processor, information that relates to at least one from among the at least one anomaly, the at least one first key metric, and the at least one second key metric; and
generating, by the at least one processor, the alert, the alert including the at least one recommended procedure and the compiled information.

8. The method of claim 1, further comprising:
receiving, by the at least one processor, feedback data from at least one stakeholder;
compiling, by the at least one processor, information that relates to at least one from among the at least one first key metric, the at least one second key metric, and the at least one anomaly; and
updating, by the at least one processor, the at least one model based on the feedback data and the compiled information.

9. The method of claim 1, wherein the at least one model includes at least one from among a machine learning model, a statistical model, a mathematical model, a process model, and a data model.

10. A computing device configured to implement an execution of a method for providing real-time analytics of time series data, the computing device comprising:
a processor;
a memory; and
a communication interface coupled to each of the processor and the memory,
wherein the processor is configured to:
generate at least one model by using an artificial neural network;
train, by using training data, the at least one model;
assess the at least one model to determine whether at least one rate is within a predetermined range;
deploy the at least one model based on a result of the assessment;
capture a first set of time series data from a data flow based on a first predetermined time period;
parse the first set of time series data to identify at least one first key metric;
capture a second set of time series data from the data flow based on a second predetermined time period;
parse the second set of time series data to identify at least one second key metric, the at least one second key metric corresponding to the at least one first key metric;
compare, in real-time, the at least one second key metric with the at least one first key metric; and
identify, by using the at least one model, at least one anomaly based on a result of the comparing and a predetermined threshold.

11. The computing device of claim 10, wherein the first set of time series data and the second set of time series data includes at least one from among a transaction rate and a transaction volume, and wherein the first predetermined time period corresponds to a window of time that precedes the second predetermined time period.

12. The computing device of claim 10, wherein the processor is further configured to:
capture a third set of time series data from the data flow based on a third predetermined time period, the third predetermined time period corresponding to the first predetermined time period;
parse the third set of time series data to identify at least one third key metric, the at least one third key metric corresponding to the at least one first key metric; and
determine at least one average key metric based on the at least one third key metric and the at least one first key metric, the at least one average key metric relating to an arithmetic mean of the at least one third key metric and the at least one first key metric.

13. The computing device of claim 12, wherein the processor is further configured to:
compare, in real-time, the at least one second key metric with the at least one average key metric; and
identify, by using the at least one model, at least one normalized anomaly based on a result of the comparing and the predetermined threshold.

14. The computing device of claim 10, wherein the processor is further configured to:
verify each of the at least one anomaly based on at least one internal resource; and
automatically determine an action for each of the at least one anomaly based on a result of the verifying, the action including at least one from among a manual review action and an automated alerting action.

15. The computing device of claim 14, wherein, for the automated alerting action, the processor is further configured to:
identify at least one stakeholder that corresponds to the at least one anomaly, the at least one stakeholder including at least one from among an internal stakeholder and an external stakeholder;
retrieve at least one predetermined preference that corresponds to the at least one stakeholder, the at least one predetermined preference relating to an alerting subscription; and
generate an alert for the at least one stakeholder based on the at least one predetermined preference.

16. The computing device of claim 15, wherein, to generate the alert, the processor is further configured to:
automatically determine at least one recommended procedure to mitigate the at least one anomaly;
compile information that relates to at least one from among the at least one anomaly, the at least one first key metric, and the at least one second key metric; and
generate the alert, the alert including the at least one recommended procedure and the compiled information.

17. The computing device of claim 10, wherein the processor is further configured to:
receive feedback data from at least one stakeholder;
compile information that relates to at least one from among the at least one first key metric, the at least one second key metric, and the at least one anomaly; and
update the at least one model based on the feedback data and the compiled information.

18. The computing device of claim 10, wherein the at least one model includes at least one from among a machine learning model, a statistical model, a mathematical model, a process model, and a data model.

19. A non-transitory computer readable storage medium storing instructions for providing real-time analytics of time series data, the storage medium comprising executable code which, when executed by a processor, causes the processor to:
generate at least one model by using an artificial neural network;
train, by using training data, the at least one model;
assess the at least one model to determine whether at least one rate is within a predetermined range;
deploy the at least one model based on a result of the assessment;
capture a first set of time series data from a data flow based on a first predetermined time period;
parse the first set of time series data to identify at least one first key metric;
capture a second set of time series data from the data flow based on a second predetermined time period;
parse the second set of time series data to identify at least one second key metric, the at least one second key metric corresponding to the at least one first key metric;
compare, in real-time, the at least one second key metric with the at least one first key metric; and
identify, by using the at least one model, at least one anomaly based on a result of the comparing and a predetermined threshold.

20. The storage medium of claim 19, wherein, when executed by the at least one processor, the executable code further causes the processor to:
receive feedback data from at least one stakeholder;
compile information that relates to at least one from among the at least one first key metric, the at least one second key metric, and the at least one anomaly; and
update, by the at least one processor, the at least one model based on the feedback data and the compiled information.
